(19) United States
(12) Patent Application Publication
(10) Pub. No.: US 2026/0010527 A1
(43) Pub. Date: Jan. 8, 2026

(54) SYSTEM AND METHOD TO OVERCOME DATA RACE CONDITIONS IN A DATABASE

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Rajeshwari VENKATRAMAN, Bangalore (IN); Himanshu PATEL, Ahmedabad (IN); Shubham TIWARI, Bhopal (IN); Avinash BHARDWAJ, Noida (IN)

(73) Assignee: JIO PLATFORMS LIMITED, Ahmedabad (IN)

(21) Appl. No.: 18/992,907

(22) PCT Filed: May 30, 2024
(86) PCT No.: PCT/IN2024/050638

§ 371 Date: Jan. 9, 2025

(30) Foreign Application Priority Data
Jun. 29, 2023 (IN) 202321043760

(51) Int. Cl. G06F 16/23

(52) U.S. Cl. CPC G06F 16/2358

(57) ABSTRACT

The present disclosure relates to a method for mitigating data race conditions in a database (218). The method comprising requesting, by two or more data sources, one or more changes to be performed on a data stored in the database (218). The method comprising capturing the requested one or more changes in a streaming job to generate one or more alarms related to the one or more changes. The method comprising generating one or more logs related to the captured one or more changes. The method comprising determining a type of operation to be performed on the stored data based on the one or more generated logs and the one or more generated alarms. The method comprising responsive to determining, performing the type of operation on the data stored in the database (218).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to the field of Database Management Systems (DBMS) and data integration. More precisely, it relates to a system for an automated Change Data Capture (CDC) mechanism to overcome a data race conditions in a database.

### BACKGROUND

Background description includes information that may be useful in understanding the present invention. It is not an admission that any of the information provided herein is prior art or relevant to the presently claimed invention, or that any publication specifically or implicitly referenced is prior art.

The organizations may at times need to move data between different database environments. For example, to create a backup of the data, or to enable sharing of the data between different database applications. The data replication systems help address this need, for example by detecting and replicating changes to the data in a database table, as a result of row operations, rather than copying the entire table and the data therein. The data replication systems can be used to synchronize the data in a target database with the data in a source database.

However, in the environments that support very large data sets, for example big data environments, present challenges related to availability, scalability, and fault-tolerance. The traditional databases or data replication systems may not scale sufficiently to handle such larger amounts of data.

Data race conditions happens whenever two processes update the database simultaneously. They occur when multiple threads or processes access shared data concurrently without proper synchronization, leading to unpredictable and erroneous behavior. Data race conditions can result in incorrect data insertion and sometimes leads to data corruptions. Data race conditions arise when at least two threads or processes perform simultaneous read and write operations on the same shared data, and at least one of the operations is a write. The exact interleaving and timing of these operations become unpredictable, potentially leading to inconsistent or unexpected results. Further, the data race conditions may lead to improper updating of the data.

However, the current techniques are inefficient in handling the race conditions in a database. Thus, there is a need for improved techniques that can overcome the race conditions in an effective manner.

### OBJECTS OF INVENTION

Some of the objects of the present disclosure, that at least one embodiment herein satisfy are as listed herein below.

It is an object of the present disclosure to overcome the above limitations and drawbacks of the existing methods for using CDC to overcome data race conditions.

It is an object of the present disclosure to address data race conditions is to ensure data consistency in a concurrent environment.

It is an object of the present disclosure to enables synchronization of data changes across multiple systems or components.

It is an object of the present disclosure to help detect conflicts that arise when multiple threads or processes attempt to modify shared data concurrently.

It is an object of the present disclosure to capture and propagate data changes in near real-time and minimize the time window for potential race conditions to occur and swiftly propagate changes to ensure consistent and up-to-date data across systems.

It is an object of the present disclosure to enhance the scalability and performance of systems by reducing contention and improving parallel processing capabilities.

It is an object of the present disclosure to contribute to system reliability by providing fault-tolerant mechanisms for capturing and processing data changes.

It is an object of the present disclosure to simplify the development and maintenance of concurrent systems by providing a structured and standardized approach to handle data races.

It is an object of the present disclosure to align the objectives of using CDC with the specific requirements and challenges of addressing data race conditions to achieve improved data consistency, concurrency control, and overall reliability in the face of concurrent access to shared data.

### SUMMARY

In an exemplary embodiment, the present invention discloses a method for mitigating data race conditions in a database. The method comprising requesting, by two or more data sources, one or more changes to be performed on a data stored in the database. The method comprising capturing the requested one or more changes in a streaming job to generate one or more alarms related to the one or more changes. The method comprising generating one or more logs related to the captured one or more changes. The method comprising determining a type of operation to be performed on the stored data based on the one or more generated logs and the one or more generated alarms. The method comprising responsive to determining, performing the type of operation on the data stored in the database.

In an embodiment, the one or more changes are related to performing data manipulation operations on the data in the database.

In an embodiment, the data manipulation operations include at least one of an insert operation, an update operation, or a delete operation.

In an embodiment, the one or more alarms include messages indicating the one or more changes to be performed on the data in the database.

In an embodiment, the messages are stored in a distributed event streaming platform.

In an embodiment, the one or more alarms include at least one of a new alarm or a clear alarm.

In an embodiment, the new alarm indicates performing the insert operation on the data in the database.

In an embodiment, an insert query is created when the new alarm is generated.

In an embodiment, the clear alarm indicates performing the update operation on the data in the database.

In an embodiment, the update operation includes updating the data with a clear time as indicated in the clear alarm.

In an embodiment, the method further comprising storing the updated data with the clear time to a history table of a distributed computing framework.

In an exemplary embodiment, the present invention discloses a system for mitigating data race conditions in a database. The system comprising a receiving unit configured for receiving a request, from two or more data sources, for performing one or more changes on a data stored in the database. The receiving unit configured for capturing the requested one or more changes in a streaming job to generate one or more alarms related to the one or more changes. A processing unit configured for generating one or more logs related to the captured one or more changes and determining a type of operation to be performed on the stored data based on the one or more generated logs and the one or more generated alarms. The processing unit configured for responsive to determining, performing the type of operation on the data stored in the database.

In an embodiment, the one or more changes are related to performing data manipulation operations on the data in the database.

In an embodiment, the data manipulation operations include at least one of an insert operation, an update operation, or a delete operation.

In an embodiment, the one or more alarms include messages indicating the one or more changes to be performed on the data in the database.

In an embodiment, the messages are stored in a distributed event streaming platform.

In an embodiment, the one or more alarms include at least one of a new alarm or a clear alarm.

In an embodiment, the new alarm indicates performing the insert operation on the data in the database.

In an embodiment, an insert query is created when the new alarm is generated.

In an embodiment, the clear alarm indicates performing the update operation on the data in the database.

In an embodiment, the update operation includes updating the data with a clear time as indicated in the clear alarm.

In an embodiment, the system further configured for storing the updated data with the clear time to a history table of a distributed computing framework.

### BRIEF DESCRIPTION OF DRAWINGS

The specifications of the present disclosure are accompanied with drawings of the system and method to aid in better understanding of the said invention. The drawings are in no way limitations of the present disclosure, rather are meant to illustrate the ideal embodiments of the said disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of the entire system with individual components for change data capture (CDC) to overcome data race conditions, in accordance with an embodiment of the present disclosure.

FIG. 2 illustrates an exemplary block diagram of all the modules of the system, in accordance with an embodiment of the present disclosure.

FIG. 3 illustrates an exemplary flow structure of a sample data race condition, in accordance with an embodiment of present disclosure.

FIG. 4 illustrates an exemplary flow diagram of a sample CDC operation, in accordance with an embodiment of the present disclosure.

FIG. 5 illustrates a block diagram of a sample CDC operation, in accordance with an embodiment of the present disclosure.

FIG. 6 illustrates an exemplary computer system in which or with which embodiments of the present invention can be utilized, in accordance with an embodiment of present disclosure.

FIG. 7 illustrates a flow diagram of a method for mitigating data race conditions in a database, in accordance with an embodiment of the present disclosure.

### LIST OF REFERENCE NUMERALS

100—Block diagram
200—Exemplary block diagram of a system
202—Receiving unit
204—Memory
206—Interfacing unit
208—Processing unit
210—Log module
212—Change data capture (CDC) module
214—Synchronization module
216—Other modules
218—Database
300—Flow structure
400—Flow diagram
500—Block diagram
600—A computer system
602—Input devices
604—Central processing unit (CPU)
608—Output devices
610—Secondary storage devices
612—Control unit
614—Arithmetic & Logical unit
700—Flow Diagram

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

The present invention provides improved techniques that can overcome the race conditions in an effective manner. The present invention employes a change data capture (CDC) technique that is used to identify and capture changes made to data in a database or data source. In an aspect, the CDC captures and records all data modifications, including inserts, updates, and deletes, as they occur, enabling real-time or near-real-time synchronization and replication of data between systems. The CDC employs an open-source distributed platform captures changes in data from the streaming data and flags them as “insert, modify and delete” for further processing. The distributed platform connects to the database's, usually Structured Query Language (SQL) databases, transaction log or replication log, depending on the supported database system. The distributed platform reads the log in a non-intrusive manner, without impacting the performance or integrity of the database. The distributed platform extracts the captured changes from the database log, including inserts, updates, and deletes. The distributed platform translates these changes into a standardized representation of events. The extracted change events are serialized into a specific format, such as JSON or Avro. The serialization enables the events to be easily transmitted and consumed by downstream systems.

The distributed platform distributes the serialized change events to downstream systems using an open-source distributed streaming platform that acts as a scalable and fault-tolerant platform, ensuring reliable delivery of the change events to consumers.

In an aspect, the present disclosure employs the CDC mechanism with the open source distributed platform to achieve a real-time, event-driven architecture where changes in databases are efficiently captured, converted, and propagated for downstream consumption. Thus, with the present disclosure changes can be made in a database to create, read, update and delete data and to overcome any race conditions due to which data may not get updated in the database properly.

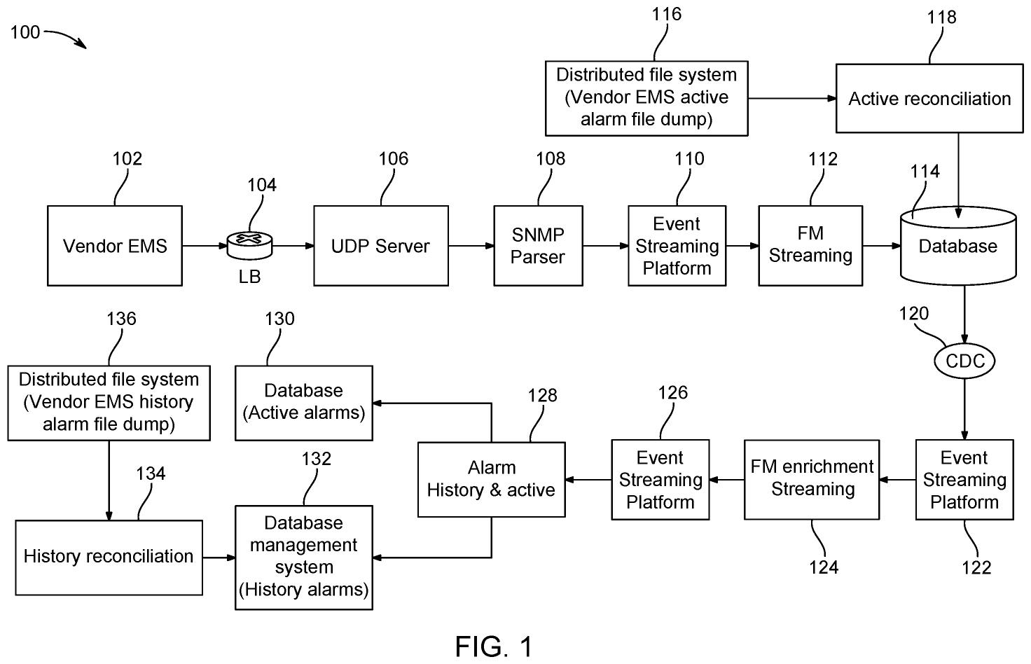

The various embodiments throughout the disclosure will be explained in more detail with reference to FIGS. 1-7.

The present disclosure relates to the field of Database Management Systems (DBMS) and data integration. More precisely, it relates to a system for an automated Change Data Capture (CDC) mechanism to overcome a data race condition.

FIG. 1 presents a schematic of a system (100) designed for the mitigation of data race conditions by employing the methodology of CDC, in accordance with one embodiment of the present disclosure. The depiction is aligned with the current embodiment, where the system (100) integrates a multitude of components to facilitate the real-time synchronization and processing of data modifications emanating from diverse sources.

According to the configuration, the system (100) includes an element management system (vendor) (EMS) (102). The EMS (102) executes the transmission of feature data using a Location Based Service (104) alongside a User Datagram Protocol (UDP) Server (106). The Vendor EMS (102) is configured for dispatching data pertinent to the manufacturing process, such as telemetry from machinery or production metrics to central data processing facilities.

Subsequent to transmission, the Simple Network Management Protocol (SNMP) Parser (108) analyses the data. The SNMP parser (108) is a component that is configured to interpret and analyze SNMP messages or packets. The SNMP parser is a protocol used for network management and monitoring, allowing network administrators to manage devices and monitor their performance. The SNMP parser typically takes raw SNMP messages or packets as input and parses them to extract relevant information such as device status, performance metrics, or configuration data. This parsed information can then be processed, displayed, or used for various network management tasks.

The SNMP Parser (108), in accordance with the embodiment, operates as a diagnostic tool that deciphers and categorizes data, similar to how a sensor array interprets various stimuli. For example, it might categorize data packets based on urgency or type of data, such as distinguishing between normal operational data and error messages.

The processed information is then relayed to the first Event Streaming Platform (110), which includes integral components, such as a second event streaming platform (122) and a third event streaming platform (126).

In conjunction, the Distributed File System (116) serves as the data archival system connected to the Event Streaming Platform (110). The Distributed File System (116) acts as a vast library, archiving vast amounts of data for future reference or analysis. In practical terms, it could store historical production data for trend analysis or maintain logs for compliance purposes.

In one embodiment, the system (100) includes a fault management (FM) Streaming module (112) for establishing a connection with a Database (114). The FM streaming module (112) implements a distributed computational task to efficiently handle events related to data changes and alarm management. Working alongside the Database (114) is an active reconciliation component (118), operational through a data processing task. The active reconciliation component (118) is configured for quality assurance process, verifying the accuracy and consistency of data after it undergoes changes. By utilizing distributed data processing capabilities, the active reconciliation component (118) can, for example, ensure that transaction records from multiple retail locations are harmonized and accurately reflected in a central inventory system.

The system (100) further includes the CDC module (120) for capturing and coordinating data operations to avert race conditions. The CDC module (120) conducts continuous surveillance over the database (114), much like a surveillance system overseeing a secured facility, to log any alterations within the data, ensuring that all transactions are recorded, and no conflicting operations occur.

The CDC module (120) transmits the captured data to an open source distributed streaming platform which aggregates the data from various sources. The open source distributed streaming platform (122) aggregates the data, ensuring its readiness for further action by another event streaming platform (126). The FM enrichment streaming (124) implements a distributed computational task to efficiently handle events related to data changes.

In addition, the system (100) is equipped with an Alarm History & Active component (128) interfacing with a database (130), a database dedicated to the supervision of active alarms. The database (130) can be likened to a dynamic ledger, capable of recording new transactions such as alarm activations and updating existing ones when an alarm is resolved. For example, when a security breach is detected and then neutralized, the database (130) logs the event and updates the status accordingly.

For the archival of historical alarm data, a column-oriented, non-relational database management system (132) is utilized, coupled with a distributed file system (136). This pairing functions similarly to a museum archive, where past exhibits, in this case, alarm histories, are catalogued and stored for retrospective examination or compliance checks, facilitated by a Historical Data Reconciliation component (134) that uses a distributed computational task.

The CDC module (120) is also scalable, designed to adapt to fluctuating data volumes by horizontally scaling, which could involve adding more servers to handle increased loads.

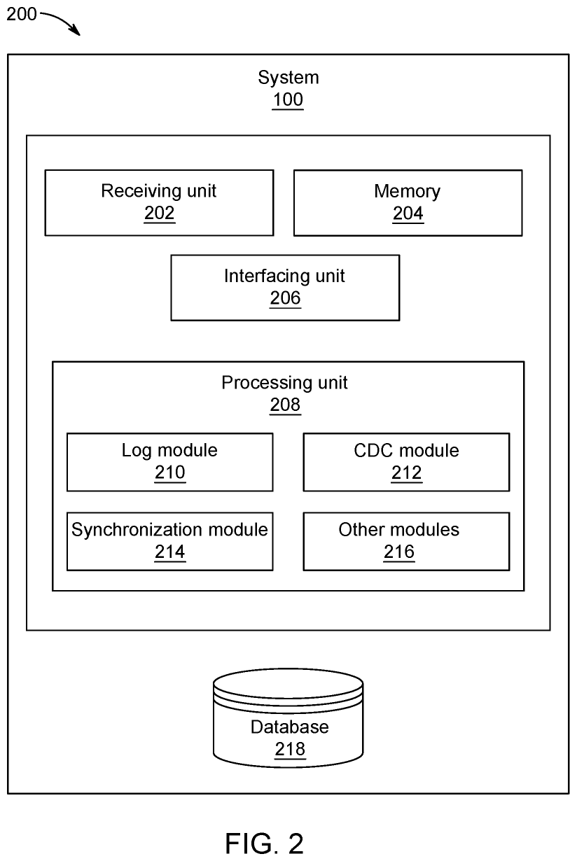

FIG. 2 provides an exemplary system (100) configured to manage and synchronize data alterations within a database environment, in accordance with one embodiment.

The system (100) includes, but may not be limited to, receiving unit (202), a memory (204), an interfacing unit (206), a processing unit (208), and a database (218). The processing unit (208) further comprises a Log module (210), a change data capture (CDC) module (212), a Synchronization module (214), and various other modules (216) which execute numerous processes. The modules are controlled by the processing unit (208) which execute instructions retrieved from the memory (204). The processing unit (208) further interact with the interfacing unit (206) to facilitate user interaction and to provide options for managing and configuring the system (100). The processing unit (208) may be implemented as one or more microprocessors, microcomputers, microcontrollers, digital signal processors, central processing units, logic circuitries, and/or any devices that process data based on operational instructions. Among other capabilities, the processing unit (208) may be configured to fetch and execute computer-readable instructions stored in a memory (204) of the system (100). The memory (204) may be configured to store one or more computer-readable instructions or routines in a non-transitory computer readable storage medium. The memory (204) may comprise any non-transitory storage device including, for example, volatile memory such as random-access memory (RAM), or non-volatile memory such as erasable programmable read only memory (EPROM), flash memory, and the like.

In an embodiment, the interfacing unit (206) may comprise a variety of interfaces, for example, interfaces for data input and output devices (I/O), storage devices, and the like. The interfacing unit (206) may facilitate communication through the system (100). The interfacing unit (206) may also provide a communication pathway for various other units/modules (216) of the system (100).

The log module (210) is configured for addressing potential data race conditions by capturing and maintaining a consistent and reliable record of data changes. The log module (210) employs a Write-Ahead Logging strategy, which ensures changes are recorded in a log before being applied to the database (218). The processing unit (208) supports integration with database (218) allowing the database (218) to capture changes from diverse data sources. The database (218) may include relational databases, NoSQL databases, or message queues. The processing unit (208) is capable of capturing and monitoring changes made to the source data in real-time or near real-time. The processing unit (208) also detects and extracts the individual data modifications, including inserts, updates, and deletes.

In an embodiment, the log module (210) is configured to overcome data race conditions and ensure reliable and accurate capture of data changes. The log module (210) is implemented for providing durability, atomicity, and consistency during the change capture process. The log module (210) ensures atomicity and durability of data changes which further ensures that a transaction's changes are either entirely committed or entirely rolled back. The log module (210) prevents partial or inconsistent updates to the shared data and avoids data race conditions resulting from incomplete transactions. The log module (210) also follows a Write-Ahead Logging strategy, where changes are first written to the log before being applied to the database. This provides a reliable record of the changes and helps in recovering from failures or crashes. In the event of a failure, the CDC module (212) can use the log to recover and reapply the captured changes, ensuring data integrity. The log module (210) may employ synchronization mechanisms, such as locks or semaphores, to ensure exclusive access to the log during write operations. This prevents multiple threads from concurrently writing to the log, preventing data race conditions. The log module (210) provides the necessary synchronization, atomicity, and durability guarantees, reducing the chances of data race conditions and ensuring reliable and accurate change capture.

The database (218) offers functionality to manage the capture, storage, and retrieval of data changes. The database (218) employs various transaction isolation levels and locking mechanisms to regulate access to shared data, ensuring that operations, such as inserts, updates, and deletes are executed in a controlled manner. The database (218) also contributes to managing the capture, storage, and retrieval of data changes in a concurrent and synchronized manner. The database (218) provides appropriate transaction isolation levels to ensure that concurrent transactions do not interfere with each other. Isolation levels like Serializable or Repeatable Read can be implemented to prevent data races by providing consistency and preventing dirty reads, non-repeatable reads, and phantom reads. The database (218) implements a locking and concurrency control mechanisms to regulate access to shared data. By acquiring locks on relevant resources, the database (218) can ensure exclusive access during data capture and prevent concurrent modifications that may lead to data races. The database (218) can provide mechanisms for change tracking and logging. This can be achieved through transaction logs, change tables, or triggers that capture data modifications at the source database. These logs and change tables serve as reliable sources of captured changes and help overcome data race conditions by providing an ordered and accurate record of modifications.

In an embodiment, the CDC module (212) is configured for avoiding the race condition in the database (218) when two or more sources are trying to access the data in the database (218). In an embodiment, to avoid this race condition, a CDC architecture s used which refers to the process of identifying and capturing changes made to the data in the database (218) and then delivering those changes in real-time to a downstream process/system.

In an embodiment, a synchronization module (214) is configured for implementing a synchronization to facilitate a concurrent access to shared resources. It implements locks, such as mutexes or semaphores, that can be utilized to achieve mutual exclusion and synchronize access to shared resources. By acquiring locks before accessing critical sections of code or shared data, threads can ensure that only one thread at a time can perform write operations, preventing data race conditions. Atomic operations provide a way to perform operations on shared resources in an indivisible and thread-safe manner. These operations ensures that no other thread can access the shared resource simultaneously, preventing race conditions. Examples include atomic variables or compare-and-swap instructions. The synchronization module (214) also utilizes database transaction mechanisms that can help overcome data race conditions. By encapsulating multiple operations within a transaction, the database ensures atomicity and isolation. The synchronization module (214) allows for consistency by providing a well-defined commit point, ensuring that either all changes within a transaction are applied, or none of them are. The other executing modules in the processing unit (208) are used for all other executing processes in the system.

The modules within the processing unit (208) are configured to integrate various types of source databases (218), including relational databases, NoSQL databases, or message queues. Thus, the system (100) is enabled to monitor and capture data changes in real-time or near real-time from a wide array of data sources, reflecting the system's versatility and adaptability in different database environments.

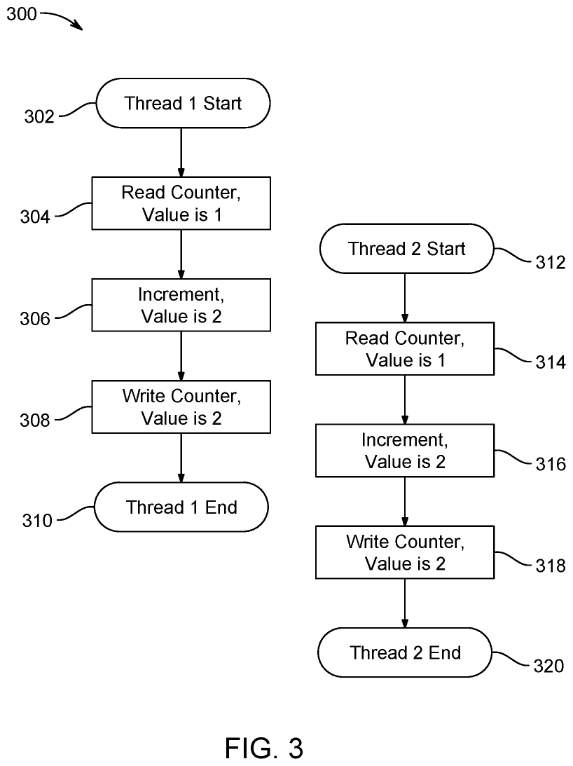

FIG. 3 illustrates a flow diagram (300) of an exemplary flow structure of a sample data race condition, in accordance with an embodiment of present disclosure.

The race condition manifests when two separate threads (302, 312) engage with a common resource concurrently and perform write operations simultaneously.

In the depicted sequence, each thread attempts to increment a shared numerical counter. Initially, Thread 1 (302) reads the counter, observing a starting value of 1 (304). Subsequently, it increments this value (306), and writes the incremented value, which is now 2, back to the shared counter (308), before completing its cycle (310). Parallel to this, Thread 2 (312) executes an analogous set of operations, reading the same initial value of 1 (314), incrementing it (316), and then writing back the new value of 2 to the shared counter (318), culminating its process (320).

The concurrent execution of these threads without appropriate synchronization leads to a data race condition, whereby the final state of the counter may not accurately reflect the total increments performed by both threads. The absence of a prescribed execution order for Thread 1 (302) and Thread 2 (312) renders the end result of the counter's value indeterminate, varying with each execution due to potential mutual interference.

To circumvent such race conditions, the implementation of synchronization controls is imperative. These controls, such as locking mechanisms or atomic operations, ensure singular access to the shared counter at any given time, thereby allowing one thread to complete its incrementation before the other commences. Effective synchronization ensures orderly and sequential increments, thereby preserving the integrity of the counter's value following concurrent operations by Thread 1 (302) and Thread 2 (312).

The flowchart (300) depicts a process of synchronization in multithreaded systems and the challenges that arise when such controls are not in place. The process emphasizes the necessity of mechanisms that enforce exclusive access to shared resources to maintain consistent and error-free operations in programs with concurrent processes.

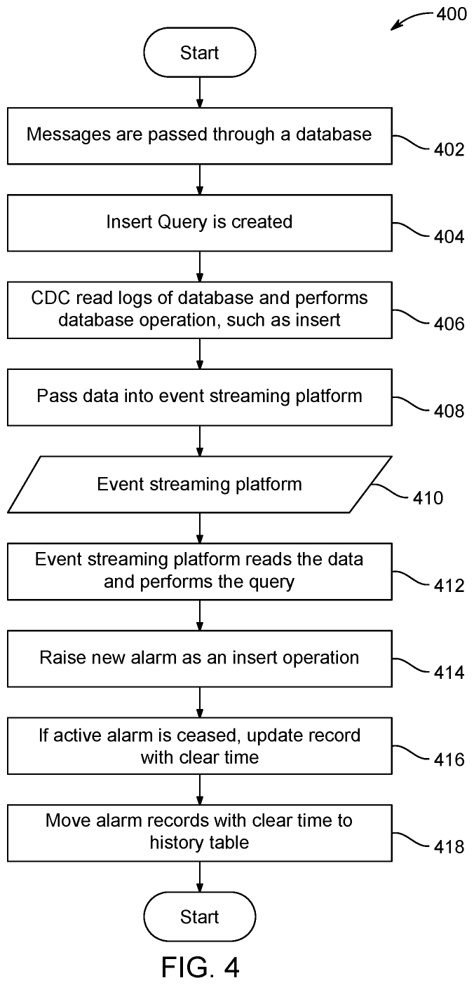

FIG. 4 offers a schematic representation (400) of the operational workflow within a Change Data Capture (CDC) system, specifically highlighting a CDC mechanism (120) in action. This diagram elucidates the step-by-step process that occurs once a database operation is initiated.

The workflow initiates when messages is passed through a database, marked by the start of the process (402). The workflow can involve a variety of database operations, but for illustrative purposes, consider an insert query that is created (404). The workflow represents a new entry being added to a database, such as a new customer record in a sales database.

Upon the creation of this insert query, the CDC mechanism (120), here represented as a part of the process flow (406), reads the logs of the database. It is responsible for identifying and executing related database operations based on the type of query detected. For example, the CDC mechanism (120) may note that a new sales transaction has occurred and will thus capture this change.

Subsequently, the captured data is passed into an event streaming platform (408) configured to facilitate real-time processing and analysis of event data, ensuring that any change or event is immediately available for necessary action or response. In the context of the sales database, the event streaming platform (408) would enable the real-time tracking of sales transactions as they occur.

Once the data is within the event streaming platform, the CDC mechanism (120) continues to monitor and react to the data. If the data corresponds to an insert operation (410), the system may raise a new alarm (412). This alarm could serve as a notification for stakeholders, indicating that a new sales transaction has been processed and may require further action, such as inventory updates or order fulfilment.

If an active alarm has to be discontinued, the CDC mechanism (120) ensures that the record is updated with the clear time (414), thereby keeping the system's records current and accurate. Completing the cycle, the alarm records with the updated clear time are then moved into a history table (416), serving as an archive for all processed events.

This comprehensive workflow demonstrates the CDC mechanism's (120) ability to capture and propagate changes throughout the system, allowing applications to respond to these changes in real-time. It enables data synchronization across multiple systems and maintains a historical record of changes, thus supporting various data analysis tasks. The workflow's systematic approach ensures that all features, as claimed, are supported literally, with the interconnectivity of each feature clearly illustrated through the flow diagram (400).

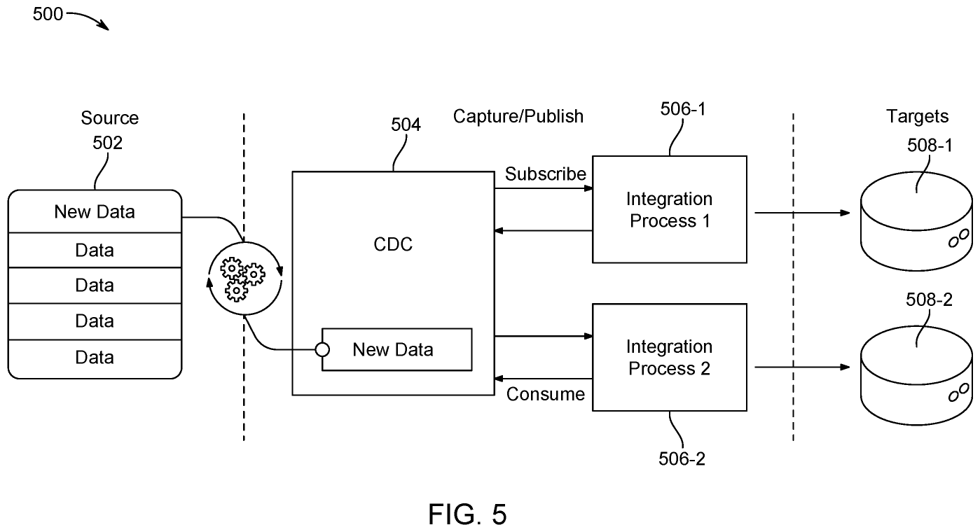

FIG. 5 presents a structured depiction (500) of a Change Data Capture (CDC) system operation according to an embodiment of the current disclosure. This block diagram delineates the flow of data from its origination to its final destination, facilitated by CDC (504).

At the source (502), new data is generated. This could be transactional records in a database from a retail sales system, where each transaction represents a new entry. As the data is generated, it is captured by the CDC mechanism (504), which is designed to monitor and log changes in the source (502).

This CDC mechanism (504) is a trigger-based system configured to act upon insert, update, and delete operations performed on the data. When an operation is conducted on the source data, such as a new sales transaction being entered the trigger is activated, capturing the details of this operation.

The captured information is then published and made available for subscription and consumption by integration processes (506-1, 506-2). These integration processes may represent various applications or systems within an enterprise that rely on real-time data, such as inventory management systems or customer relationship management software. For instance, integration process 1 (506-1) might update an inventory database to reflect a sale, reducing the stock level of the sold item. Simultaneously, integration process 2 (506-2) could update a customer's purchase history in a separate system.

The targets (508-1, 508-2) represent the final repositories for the processed data. These could be databases in a data warehouse where comprehensive records are kept for analytical purposes or data lakes where raw data is stored for future processing. Target 1 (508-1) might store a detailed transaction log for financial auditing, while target 2 (508-2) could hold customer behavior data for marketing analysis.

The system's ability to capture and integrate changes in real-time ensures that the data in targets (508-1, 508-2) is always current and reflective of the latest state of the source (502). This immediate reflection of changes allows organizations to make informed decisions based on the most recent data, avoiding the consequences of outdated information which could lead to missed opportunities or business errors.

Each component within this system (500) is interconnected, ensuring that data flows seamlessly from the point of creation to the point of utilization. The CDC mechanism (504) acts as a central hub in this process, guaranteeing that every change at the source (502) is tracked and mirrored across all systems and platforms that depend on this data.

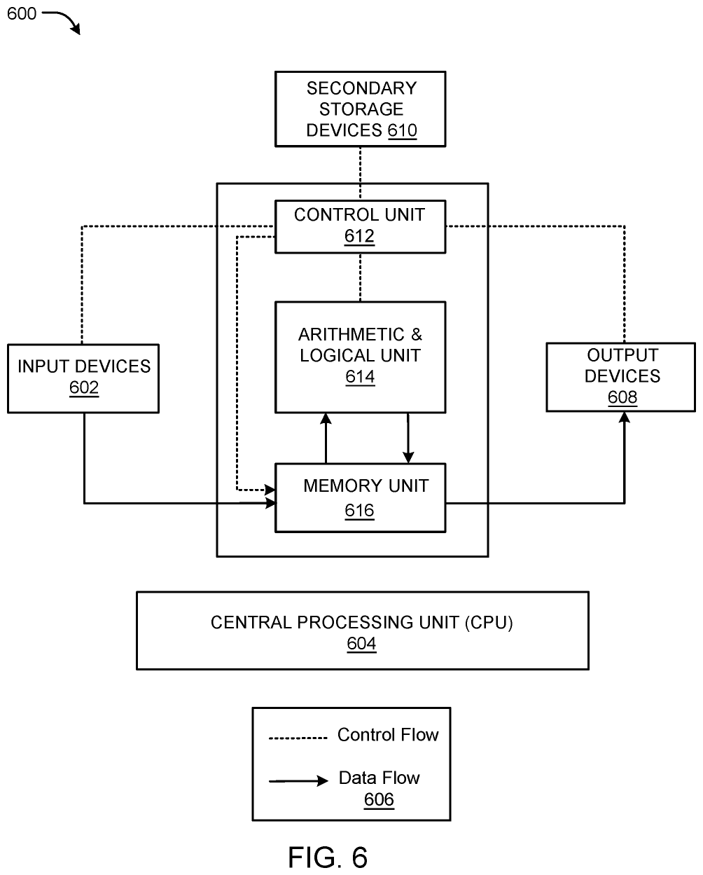

FIG. 6 illustrates an exemplary computer system in which or with which embodiments of the present invention can be utilized, in accordance with an embodiment of present disclosure.

Referring to FIG. 6, a block diagram of an exemplary computer system is disclosed. The computer system includes input devices (602) connected through I/O peripherals. The system also includes a Central Processing Unit (CPU) (604), and Output Devices (608), connected through the I/O peripherals. The CPU (604) is also attached to a memory unit 616 along with an Arithmetic and Logical Unit (ALU) (614), a control unit (612), along with secondary storage devices (610) such as Hard Disks and a Secure Digital Card (SD). The data flow and control flow (606) is indicated by a straight and dashed arrow respectively. The CPU consists of data registers that hold the data bits, pointers, cache, Random Access Memory (RAM) (204), and a main processing unit containing the processing unit (208). The system also consists of communication buses that are used to transport the data internally in the system.

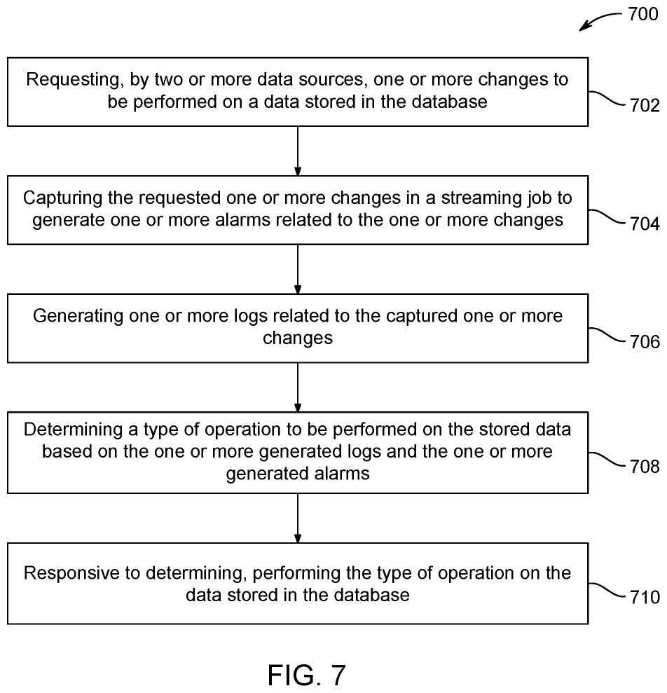

FIG. 7 is a flowchart depicting a method for mitigating data race conditions in a database system.

At step 702, the method comprising requesting, by two or more data sources, one or more changes to be performed on a data stored in the database. In an aspect, the data sources may include a streaming data source, or a file based data source. The streaming data sources are a continuous and real-time provider of data that emits data records over the time. The streaming data sources generate data continuously and produce large volumes of data at high frequencies. In an aspect, a file-based data source refers to a data source where data is stored and organized in files on a file system. These files can contain structured or unstructured data and are typically stored in formats such as text files, comma separated values (CSV) files, JavaScript object notation (JSON) files, extensible markup language (XML) files etc.

At step 704, the method comprising capturing the requested one or more changes in a streaming job to generate one or more alarms related to the one or more changes.

At step 706, the method comprising generating one or more logs related

to the captured one or more changes.

At step 708, the method comprising determining a type of operation to be performed on the stored data based on the one or more generated logs and the one or more generated alarms.

At step 710, the method comprising responsive to determining, performing the type of operation on the data stored in the database.

In an embodiment, the one or more changes are related to performing data manipulation operations on the data in the database.

In an embodiment, the data manipulation operations include at least one of an insert operation, an update operation, or a delete operation.

In an embodiment, the one or more alarms include messages indicating the one or more changes to be performed on the data in the database.

In an embodiment, the messages are stored in a distributed event streaming platform.

In an embodiment, the one or more alarms include at least one of a new alarm or a clear alarm.

In an embodiment, the new alarm indicates performing the insert operation on the data in the database.

In an embodiment, an insert query is created when the new alarm is generated.

In an embodiment, the clear alarm indicates performing the update operation on the data in the database.

In an embodiment, the update operation includes updating the data with a clear time as indicated in the clear alarm.

In an embodiment, the method further comprising storing the updated data with the clear time to a history table of a distributed computing framework.

In an exemplary embodiment, the present invention discloses a system for mitigating data race conditions in a database. The system comprising a receiving unit configured for receiving a request, from two or more data sources, for performing one or more changes on a data stored in the database. The receiving unit configured for capturing the requested one or more changes in a streaming job to generate one or more alarms related to the one or more changes. A processing unit configured for generating one or more logs related to the captured one or more changes and determining a type of operation to be performed on the stored data based on the one or more generated logs and the one or more generated alarms. The processing unit configured for responsive to determining, performing the type of operation on the data stored in the database.

In an embodiment, the one or more changes are related to performing data manipulation operations on the data in the database.

In an embodiment, the data manipulation operations include at least one of an insert operation, an update operation, or a delete operation.

In an embodiment, the one or more alarms include messages indicating the one or more changes to be performed on the data in the database.

In an embodiment, the messages are stored in a distributed event streaming platform.

In an embodiment, the one or more alarms include at least one of a new alarm or a clear alarm.

In an embodiment, the new alarm indicates performing the insert operation on the data in the database.

In an embodiment, an insert query is created when the new alarm is generated.

In an embodiment, the clear alarm indicates performing the update operation on the data in the database.

In an embodiment, the update operation includes updating the data with a clear time as indicated in the clear alarm.

In an embodiment, the system further configured for storing the updated data with the clear time to a history table of a distributed computing framework.

Further, if one source, deletes one of the records and second source is trying to add the record, the present invention will create two entries, one deletion and one insertion for the same record. Thus, by comparing the two entries for the same record and ignoring the insertion of the record as it has been deleted.

It is to be appreciated by a person skilled in the art that while various embodiments of the present disclosure have been elaborated for using CDC (120) to overcome data race conditions. However, the teachings of the present disclosure are also applicable for other types of applications as well, and all such embodiments are well within the scope of the present disclosure. However, the system and method for sign language conversion is also equally implementable in other industries as well, and all such embodiments are well within the scope of the present disclosure without any limitation.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While considerable emphasis has been placed herein on the preferred embodiments it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The proposed invention provides a system for CDC for overcoming data race conditions.

The proposed invention provides a system that eliminates the risk of concurrent conflicting operations that can lead to data inconsistencies or incorrect outcomes, providing reliable and accurate data capture.

The proposed invention provides a system that mitigates the impact of failures, such as system crashes or network disruptions, by ensuring proper sequencing of operations and enabling recovery from unexpected events.

The proposed invention provides a system that supports concurrent access to shared resources, allowing for improved concurrency and scalability.

The proposed invention provides a system that eliminates unnecessary retries, rollbacks or duplicated operations that can waste computational resources.

The proposed invention provides a system that overcomes data race conditions which allows for real-time or near real-time data capture.

The proposed invention provides a system that provides clear guidelines and mechanisms for handling data race conditions in CDC processes.

The proposed invention provides a system that integrates data from different sources or propagating changes to downstream systems, ensuring synchronized and coherent data flow.

The proposed invention provides a system that can handle growing workloads and adapt to changing environments, providing a scalable and adaptable solution for capturing data changes.

1. A method for mitigating data race conditions in a database, the method comprising:
requesting, by two or more data sources, one or more changes to be performed on a data stored in the database;
capturing the requested one or more changes in a streaming job to generate one or more alarms related to the one or more changes;
generating one or more logs related to the captured one or more changes;
determining a type of operation to be performed on the stored data based on the one or more generated logs and the one or more generated alarms; and
responsive to determining, performing the type of operation on the data stored in the database.

2. The method as claimed in claim 1, wherein the one or more changes are related to performing data manipulation operations on the data in the database.

3. The method as claimed in claim 2, wherein the data manipulation operations include at least one of an insert operation, an update operation, or a delete operation.

4. The method as claimed in claim 1, wherein the one or more alarms include messages indicating the one or more changes to be performed on the data in the database, wherein the messages are stored in a distributed event streaming platform.

5. (canceled)

6. The method as claimed in claim 1, wherein the one or more alarms include at least one of a new alarm or a clear alarm.

7. The method as claimed in claim 6, wherein the new alarm indicates performing an insert operation on the data in the database.

8. The method as claimed in claim 7, wherein an insert query is created when the new alarm is generated.

9. The method as claimed in claim 6, wherein the clear alarm indicates performing an update operation on the data in the database.

10. The method as claimed in claim 9, wherein the update operation includes updating the data with a clear time as indicated in the clear alarm.

11. (canceled)

12. A system for mitigating data race conditions in a database, the system comprising:
a receiving unit configured for:
receiving a request, from two or more data sources, for performing one or more changes on a data stored in the database; and
capturing the requested one or more changes in a streaming job to generate one or more alarms related to the one or more changes;
a processing unit configured for:
generating one or more logs related to the captured one or more changes;
determining a type of operation to be performed on the stored data based on the one or more generated logs and the one or more generated alarms; and
responsive to determining, performing the type of operation on the data stored in the database.

13. The system as claimed in claim 12, wherein the one or more changes are related to performing data manipulation operations on the data in the database.

14. The system as claimed in claim 13, wherein the data manipulation operations include at least one of an insert operation, an update operation, or a delete operation.

15. The system as claimed in claim 12, wherein the one or more alarms include messages indicating the one or more changes to be performed on the data in the database, wherein the messages are stored in a distributed event streaming platform.

16. (canceled)

17. The system as claimed in claim 12, wherein the one or more alarms include at least one of a new alarm or a clear alarm.

18. The system as claimed in claim 17, wherein the new alarm indicates performing an insert operation on the data in the database.

19. The system as claimed in claim 18, wherein an insert query is created when the new alarm is generated.

20. The system as claimed in claim 17, wherein the clear alarm indicates performing an update operation on the data in the database.

21. The system as claimed in claim 20, wherein the update operation includes updating the data with a clear time as indicated in the clear alarm.

22. (canceled)

23. A computer program product comprising a non-transitory computer-readable medium comprising instructions that, when executed by one or more processors, cause the one or more processors to perform a method for mitigating data race conditions in a database, the method comprising:
requesting, by two or more data sources, one or more changes to be performed on a data stored in the database;
capturing the requested one or more changes in a streaming job to generate one or more alarms related to the one or more changes;
generating one or more logs related to the captured one or more changes;
determining a type of operation to be performed on the stored data based on the one or more generated logs and the one or more generated alarms; and
responsive to determining, performing the type of operation on the data stored in the database.
